(19) United States
(12) Patent Application Publication
(10) Pub. No.: US 2025/0045876 A1
(43) Pub. Date: Feb. 6, 2025

(54) NON-TRANSITORY STORAGE MEDIUM STORING SUPERVISED DATA GENERATION PROGRAM, SUPERVISED DATA GENERATION METHOD, SUPERVISED DATA GENERATION APPARATUS, TRAINING APPARATUS, AND DATA STRUCTURE OF SUPERVISED DATA

(71) Applicants: MICWARE CO., LTD., Hyogo (JP); Noah Solution Inc., Tokyo (JP)

(72) Inventors: Shusuke SUZUE, Hyogo (JP); Yoshinori SAKABE, Hyogo (JP); Penggui TANG, Tokyo (JP)

(21) Appl. No.: 18/787,988

(22) Filed: Jul. 29, 2024

(30) Foreign Application Priority Data
Jul. 31, 2023 (JP) 2023-124769

(51) Int. Cl. G06T 5/50; G06T 7/194

(52) U.S. Cl. CPC G06T 5/50; G06T 7/194; G06T 2207/20221

(57) ABSTRACT

A technique generates supervised data without a background image in actual use. Supervised data generation program is a program for generating supervised data to generate a trained model for outputting a result from identifying a target in response to input image data of an image including the target corresponding to a target image. The program causes a computer to perform operations including selecting a first target image from an image group including a plurality of different target images and performing a transformation process to generate a background image, and selecting a second target image from the image group and combining the second target image with the background image to generate supervised data.

### BACKGROUND OF INVENTION

### Field of the Invention

The present invention relates to a technique for detecting an intended target from an image.

### Background Art

In recent years, object detection algorithms such as You Only Look Once (YOLO) and Single Shot MultiBox Detector (SSD) have been used to detect targets in various business fields. To correctly detect a target, a trained model for detecting an object is to be trained with a sufficient volume of high-quality supervised data.

A technique known as data augmentation artificially augments the number of data pieces by processing an image in the supervised data with, for example, translation, scaling, rotation, or noise addition.

For example, Patent Literature 1 describes a technique for such data augmentation. Patent Literature 1 describes an information processing apparatus for selecting an image suitable for machine learning. The information processing apparatus includes an identifier that identifies, when a composite image generated by superimposing multiple element images of a target element on a background image includes element images overlapping one another, a shielding degree indicating a degree by which a first element image placed in the back is shielded by a second element image placed in the front, and a selector that selects, when the shielding degree is less than or equal to an upper limit value specified by the complexity of the first element image, a composite image used as supervised data in machine learning for generating a recognition model to detect the target element.

### CITATION LIST

### Patent Literature

Patent Literature 1: Japanese Unexamined Patent Application Publication No. 2022-26456

### SUMMARY OF INVENTION

Artificial intelligence (AI) for object detection separates a target from an image including both the target and a background image. Machine learning relies on, in addition to the features of the target, information (knowledge) about the background image. The learned knowledge about the background image may ideally match knowledge about the background image in actual use. However, the background image in actual use may be unavailable.

One or more aspects of the present invention are directed to a technique for generating supervised data without a background image in actual use.
(1) A supervised data generation program according to one aspect of the present invention is a program for generating supervised data to generate a trained model for outputting a result from identifying a target in response to input image data of an image including the target corresponding to a target image. The program causes a computer to perform operations including selecting a first target image from an image group including a plurality of different target images and performing a transformation process to generate a background image, and selecting a second target image from the image group and combining the second target image with the background image to generate supervised data.
(2) In the supervised data generation program described above, the transformation process may be performed on a divided image of the first target image.
(3) A supervised data generation method according to another aspect of the present invention is a method for generating supervised data to generate a trained model for outputting a result from identifying a target in response to input image data of an image including the target corresponding to a target image. The method is implementable with a computer and includes selecting a first target image from an image group including a plurality of the target images and performing a transformation process to generate a background image, and selecting a second target image from the image group and combining the second target image with the background image to generate supervised data.
(4) A supervised data generation apparatus according to another aspect of the present invention is an apparatus for generating supervised data to generate a trained model for outputting a result from identifying a target in response to input image data of an image including the target corresponding to a target image. The apparatus includes a background image generator that selects a first target image from an image group including a plurality of different target images and performs a transformation process to generate a background image, and a supervised data generator that selects a second target image from the image group and combines the second target image with the background image to generate supervised data.
(5) A training apparatus according to another aspect of the present invention includes a background image generator that selects a first target image from an image group including a plurality of different target images and performs a transformation process to generate a background image, a supervised data generator that selects a second target image from the image group and combines the second target image with the background image to generate a plurality of supervised data pieces, and a trained model generator that generates, with the plurality of supervised data pieces, a trained model for outputting a result from identifying a target in response to input image data of an image including the target corresponding to a target image.
(6) A data structure of supervised data according to another aspect of the present invention includes image data of a supervised image for generating a trained model for outputting a result from identifying a target in response to input image data of an image including the target corresponding to a target image. The supervised image includes a second target image selected from an image group including a plurality of the target images corresponding to the target to be identified from one another by the trained model, and a background image located around the second target image. The background image includes a transformed image resulting from a transformation process performed on a first target image selected from the image group.
(7) The data structure of supervised data described above may further include positional information about the second target image with respect to the background image. The supervised data and other data can be generated efficiently.

### BRIEF DESCRIPTION OF THE DRAWINGS

FIG. 1 is a functional block diagram of a trained model generation apparatus according to an embodiment.

FIG. 2 is a flowchart of a target identification process in an embodiment.

FIG. 3 is a schematic diagram of an example hardware configuration.

FIG. 4 is a flowchart of a target image generation process in an embodiment.

FIG. 5 is a flowchart of a background image generation process in an embodiment.

FIG. 6 is a schematic diagram of the data structure of supervised data according to an embodiment.

FIG. 7 is a table showing an example data structure of a database of a supervised dataset.

FIG. 8 is a table of example target detection results output from a trained model.

FIG. 9 is a schematic diagram of an image in comparative example 1.

FIG. 10 is a schematic diagram of images in comparative example 2 and comparative example 3.

FIG. 11 is a schematic diagram of a supervised image in supervised data in another embodiment.

FIG. 12 is a schematic diagram of a supervised image in supervised data in another embodiment.

FIG. 13 is a schematic diagram of a supervised image in supervised data in another embodiment.

### DETAILED DESCRIPTION

### 1. Overview

### Introduction

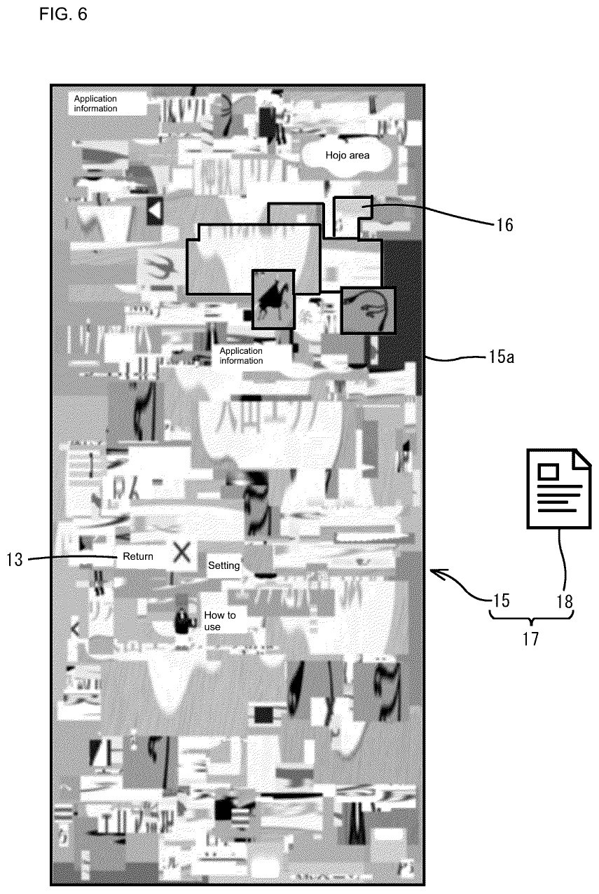

Supervised data (refer to FIG. 6) to be generated in the present embodiment includes a characteristic background image. The background image includes transformed images resulting from a transformation process performed on a target image that is a target of recognition. The background image resembles the target image and is almost indistinguishable, providing abundant background information to a trained model to increase the training efficiency.

For example, an application display includes multiple types of buttons or icons. For a user interface (UI) or user experience (UX), the style (colors and patterns) of such multiple types of buttons or icons tend to approximate to the style of the entire background of the display including the buttons or icons. Thus, the background image generated with multiple types of icons can easily reflect the features (e.g., color distribution or pattern) of the background of the application, thus increasing the training efficiency.

### Trained Model 10

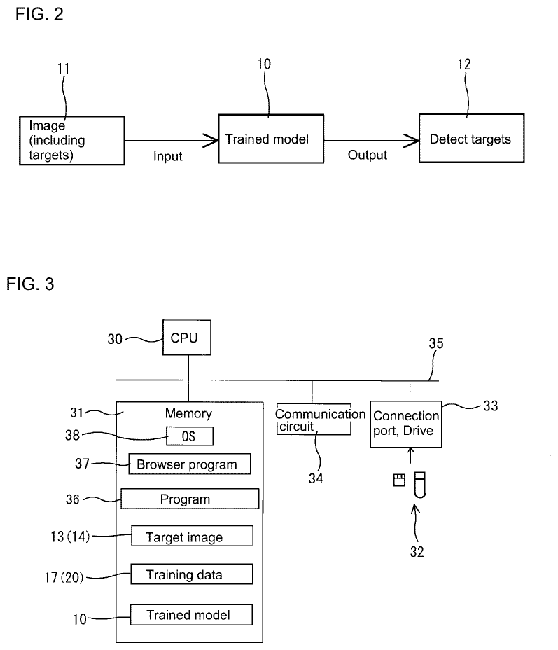

Referring to FIG. 2, a trained model generated through machine learning with the supervised data in the present embodiment will be described first. A trained model 10 as illustrated outputs the result from identifying targets 12 in response to input image data of an image 11.

The trained model 10 is, for example, an object detection algorithm such as You Only Look Once (YOLO) or Single Shot MultiBox Detector (SSD).

### Image 11

The image 11 includes the targets 12 to be recognized by the trained model 10. The image 11 may be a still image or a video. A video may be a set of images captured at predetermined intervals. Examples of such images include captured images on the screen and images captured with, for example, a camera, an in-vehicle camera, or a surveillance camera.

### Target

A target is an object to be detected in the image 11. A target detected by the trained model is indicated with, for example, a frame (not shown) surrounding the target. The target may instead be indicated with an arrow or a color to be distinguishable from other portions.

### Supervised Data Generation Apparatus 1 and Training Apparatus 4

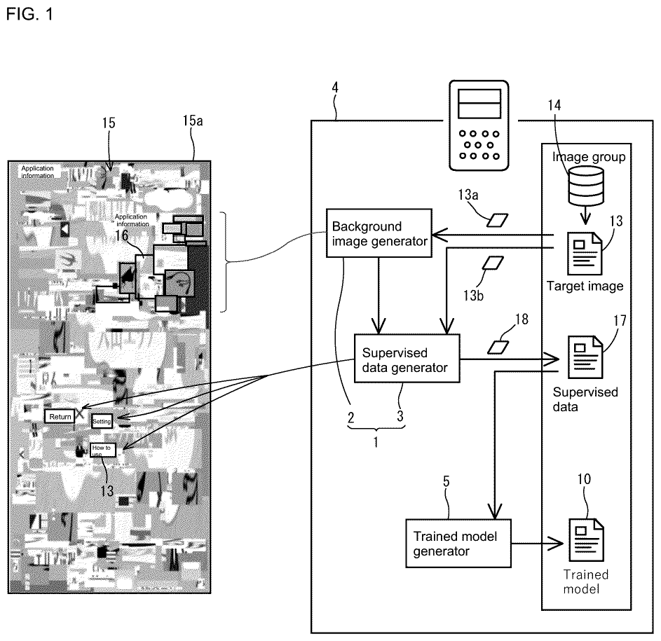

A supervised data generation apparatus will be described with reference to FIG. 1. A supervised data generation apparatus 1 as illustrated includes a background image generator 2 and a supervised data generator 3.

A training apparatus 4 includes the supervised data generation apparatus 1 and a trained model generator 5.

### 2. Components

### Background Image Generator 2

The background image generator 2 selects a first target image 13a from an image group 14 including multiple different target images 13 and processes the first target image 13a through a transformation process including, for example, enlargement, reduction, rotation, and inversion to generate a background image 15.

### Target Images 13 and 13a

The target images 13 are images of targets included in the image 11.

The first target image 13a includes one or more target images 13 used to generate the background image 15.

### Image Group 14

The image group 14 includes the multiple target images 13 to be identified. The target images 13 in the image group 14 are identifiable from one another by the trained model 10. The image group 14 is stored in a storage 31 (described later). The image group 14 may be stored in an external server.

### Background Image 15

The background image 15 includes transformed images 16 arranged in a background frame 15a. In the present embodiment, the transformed images 16 are randomly arranged until the background frame 15a is filled. The transformed images 16 may or may not overlap one another. The rectangles denoted with 16 in the background frame 15a indicate some of the transformed images 16 being arranged.

### Transformed Image 16 and Transformation Process

The transformed images 16 are generated through the transformation process of the first target image 13a selected from the image group 14. The transformation process includes enlargement, reduction, rotation, vertical inversion, and lateral inversion. The transformation process may further include, for example, noise addition and projective transformation. For example, typical data augmentation may also be used.

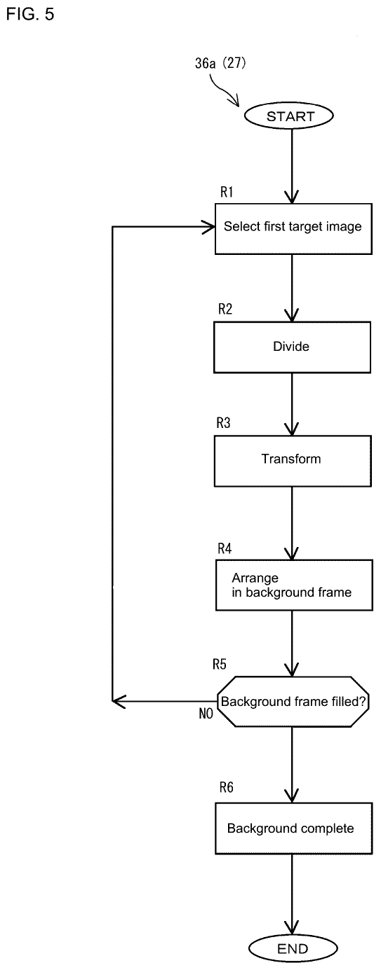

The transformation process corresponds to processes R2 and R3 in FIG. 5 (described later).

### Supervised Data Generator 3

The supervised data generator 3 selects second target images 13b from the image group 14 and combines the second target images 13b with the background image 15 to generate supervised data 17 (refer to FIG. 6).

### Second Target Image 13b

The second target images 13b include one or more target images 13 to be combined with the background image 15.

### Supervised Data 17

The supervised data 17 is used in supervised training in machine learning. In the

present embodiment, the supervised data 17 includes the background image 15, the target images 13, and positional information 18. The supervised data 17 will be described in detail later with reference to FIG. 6.

### 3. Hardware Configuration

The hardware configuration of the supervised data generation apparatus 1 and the training apparatus 4 will now be described with reference to FIG. 3.

### Hardware Configuration of Supervised Data Generation Apparatus 1 and Training Apparatus 4

The hardware configuration of the supervised data generation apparatus 1 will be described. The hardware configuration of the training apparatus 4, which is substantially the same as the hardware configuration of the supervised data generation apparatus 1, will not be described.

As shown in FIG. 3, the supervised data generation apparatus 1 according to the present embodiment is a computer including a central processing unit (CPU) 30 or a graphics processing unit (GPU) 30. The CPU 30 is connected to, with a bus line 35, a memory (hereafter referred to as the storage) 31, a connection port 33 for connection to and reading from, for example, a storage device 32, and a communication circuit 34 for external communication through a network.

The storage 31 stores programs 36 and 36a for generating the supervised data and the trained model. The storage 31 may also store a browser program 37 and an operating system (OS) 38. The programs 36 and 36a are, for example, installed from the storage device 32. The target images 13 (the image group 14), the supervised data 17, and the trained model 10 stored in the storage 31 in the present embodiment may be stored in an external server.

In the present embodiment, the program 36 may cooperate with the OS 38 while using its functions, and the program 36a may cooperate with the browser program 37 while using its functions. The programs 36 and 36a may operate independently of the browser programs 37 and the OS 38 without using their functions.

In the hardware configuration of the programs 36 and 36a described above, the functions shown in the functional block diagram in FIG. 1 can be implemented with, for example, the CPU 30 and the programs 36 and 36a. However, the functions may be partly or entirely sequence-controlled with a logic circuit of, for example, a microcomputer, or with a programmable logic controller (PLC).

### 4. Programs

### Flowchart of Supervised Data Generation Process

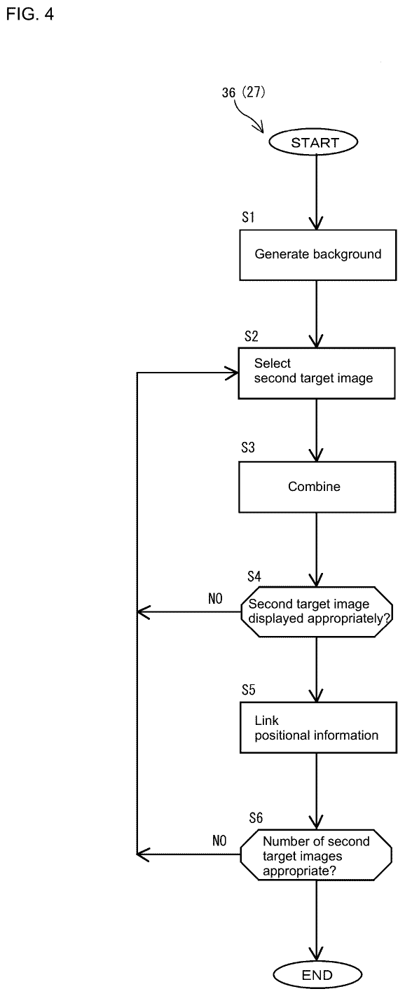

FIG. 4 is a flowchart of a process based on the programs 36 and 36a executed by the supervised data generation apparatus 1 according to an embodiment.

The steps described below include generating a single piece of supervised data 17. However, the steps described below actually include generating many different pieces of supervised data 17. Multiple pieces of supervised data 17 may be generated simultaneously with parallel processing.

### S0: Preprocessing

In preprocessing S0 (not shown), the file format of the image data of the target images 13 to be processed with the program 36 is converted to a predetermined format.

### S1: Generation of Background Image

The CPU 30 (refer to FIG. 3) in the supervised data generation apparatus 1 generates the background image 15.

The background image generation will now be described with reference to FIG. 5. FIG. 5 is a flowchart of a process based on the program 36a executed by the supervised data generation apparatus 1 in an embodiment.

### R1: Selection of Target Image

The first target image 13a is randomly selected from the image group 14 (refer to FIG. 1).

### R2: Division

The vertical direction or the lateral direction in the selected first target image 13a is selected randomly. The vertical and lateral directions are predetermined for each target image 13. Three-, four-, or five-division is selected randomly. The image is divided into the selected division number in a direction parallel to the selected direction. A single image is randomly selected from three to five images generated by dividing the first target image 13a.

### R3: Transformation Process

The selected divided image is processed through the transformation process to generate each transformed image 16 (refer to FIG. 6). A transformation process is randomly selected from multiple transformation processes preliminarily registered. In the present embodiment, one of the registered transformation processes, including rotation or inversion, enlargement or reduction, or both of the enlargement or reduction and the rotation or inversion, is selected randomly. The rectangles denoted with 16 in the background frame 15a indicate some of the transformed images 16 being arranged.

### R4: Arrangement in Background Frame

The transformed images 16 are arranged in the background frame 15a. In the present embodiment, the transformed images 16 are randomly arranged in the background frame 15a. In the present embodiment, the transformed images 16 may overlap one another. The transformed images 16 subsequently arranged are superimposed on the transformed images 16 previously arranged.

### R5: Background Frame Filled?

When the background frame 15a is filled with the transformed images 16, the processing advances to the subsequent step. When the background frame 15a is yet to be filled, the processing returns to step R1. Without the background frame 15a being fully filled, the processing may advance to the subsequent step when a predetermined portion of the background frame 15a is filled. The predetermined portion is, for example, 90 to 95% of the area in the background frame 15a.

### R6: Completion of Background

The background image 15 is complete.

### S2: Selection of Second Target Image

Referring back to FIG. 4, the second target images 13b are selected randomly. The image selected as the first target image 13a may be entirely or partially included.

When a specific second target image 13b is selected by other supervised data 17 many times, the probability of this second target image 13b being selected is adjusted to decrease. When the specific second target image 13b is selected fewer times, the probability of this second target image 13b being selected is adjusted to increase. In a supervised dataset 20, the number of times a second target image 13b being selected is adjusted to be the same or substantially the same among different pieces of supervised data.

Although the number of times a second target image 13b being selected is adjusted with, for example, a roulette wheel selection method in the present embodiment, another known method may be used instead.

When the processes for generating different pieces of supervised data 17 are performed in parallel to one another, the number of times the specific second target image 13b being selected in each process is added up, and the probability of the second target image 13b being selected in the subsequent selection in each process is increased or decreased to dynamically adjust and balance the probability of each second target image 13b being selected.

### S3: Combination

The second target images 13b are randomly arranged on the resulting background image 15. The second target images 13b are combined to be superimposed on the background image 15.

The positional information 18 about the second target images 13b with respect to the background frame 15a is stored. Each second target image 13b may have a starting point corresponding to the positional information 18 at the center, the center of gravity, or a corner of the rectangle.

The information about the second target images 13b to be stored with the positional information 18 may include, for example, the shape of each second target image 13b such as a square, a rectangle, or a circle, or the dimensions such as the lengths of the sides or the diameter.

### S4: Target Image Displayed Appropriately?

The determination is performed as to whether the combined second target images 13b are displayed appropriately on the background image 15. For example, when none of the conditions (a), (b), or (c) holds, the image is displayed appropriately and the processing advances to the subsequent step.
(a) Multiple second target images 13b overlap one another.
(b) A second target image 13b is larger than the background frame 15a.
(c) A second target image 13b extends beyond the background frame 15a.

When any one of the conditions (a), (b), and (c) holds, the combining in step S3 is canceled. The processing returns to step S2.

### S5: Linking Positional Information

The positional information 18 about the combined second target images 13b is linked to the background image 15 and stored into the storage 31.

### S6: Number of Target Images Appropriate?

When the number of second target images 13b is less than a predetermined number, the processing returns to step S2. When the number of second target images 13b reaches the predetermined number, the processing ends.

In the present embodiment, the number of second target images 13b is randomly determined between 10 and 20. The number of second target images 13b is determined between step S1 and step S2. The number of second target images 13b may be determined in another step.

### Other Processing

The processes described above performed by randomly selecting or randomly arranging the images may be partially or entirely performed by selecting or placing the images in a preset order.

The dividing process in R2 may be eliminated. In this case, the second target images 13b to be identified may not be easily distinguishable from the transformed images 16 of the background image. Thus, the transformation process including enlargement or reduction alone and rotation or inversion alone may be eliminated.

When the background image is generated, the transformed images 16 may be arranged without overlapping one another.

### Supervised Data 17

FIG. 6 is a schematic diagram of an example data structure of supervised data. The supervised data 17 in the figure has the same structure as the structure described for the supervised data generation apparatus 1. Like reference numerals denote like elements, and such elements will not be described.

The illustrated supervised data 17 is used in machine learning to generate the trained model 10 that outputs a result from identifying a target 12 in response to input image data of the image 11 including the target 12 corresponding to the target image 13. The supervised data 17 includes a supervised image 19 and the positional information 18.

### Supervised Image 19

The supervised image 19 includes the second target images 13b selected from the image group 14 of the multiple target images 13 corresponding to the targets 12 and to be identified from one another by the trained model 10, and the background image 15 located around the second target image 13b. The background image 15 includes the transformed images 16 resulting from the transformation process performed on the first target image 13a selected from the image group 14.

### Supervised Dataset

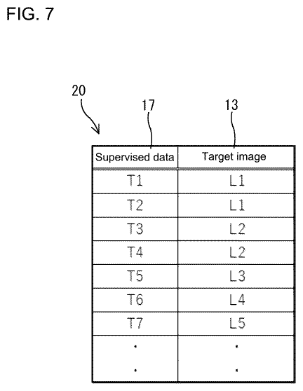

FIG. 7 is a table showing an example data structure of a supervised dataset. The supervised dataset 20 shown in the table includes the supervised data 17 and the target images 13. For example, supervised data T1 learns a target image L1 through machine learning.

### Machine Learning

Referring back to FIG. 1, the trained model generator 5 generates the trained model 10 through iteration learning based on the supervised dataset 20 stored in the storage 31. The trained model 10 may be generated with any of various methods. The trained model generator 5 stores the generated trained model 10 into the storage 31.

### Detection Result 21

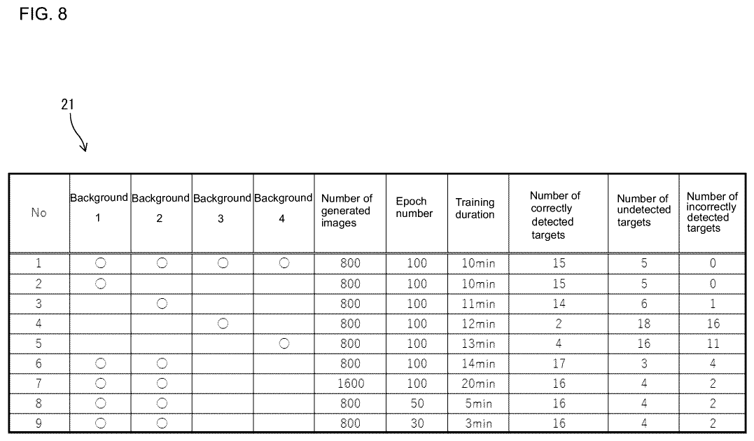

FIG. 8 is a table showing example results from detecting the targets 12 output from a trained model. Detection results 21 in the table include the detection number, Backgrounds 1 to 4, the number of generated images, the epoch number, the training duration, the number of correctly detected targets, the number of undetected targets, and the number of incorrectly detected targets. The total number of targets to be detected is 20.

The detection number in the table identifies the supervised dataset 20. The number of generated images is the number of pieces of supervised data in the supervised dataset 20. The epoch number is the number of iterations in the iteration learning. The training duration is the time taken to generate the trained model. The number of correctly detected targets is the number of targets detected correctly. The number of undetected targets is the number of targets undetected. The number of incorrectly detected targets is the number of detection erroneously detecting the target.

### Background 1

Background 1 is the background image 15 (refer to FIG. 6) generated with the method according to the present embodiment.

### Background 2: Comparative Example 1

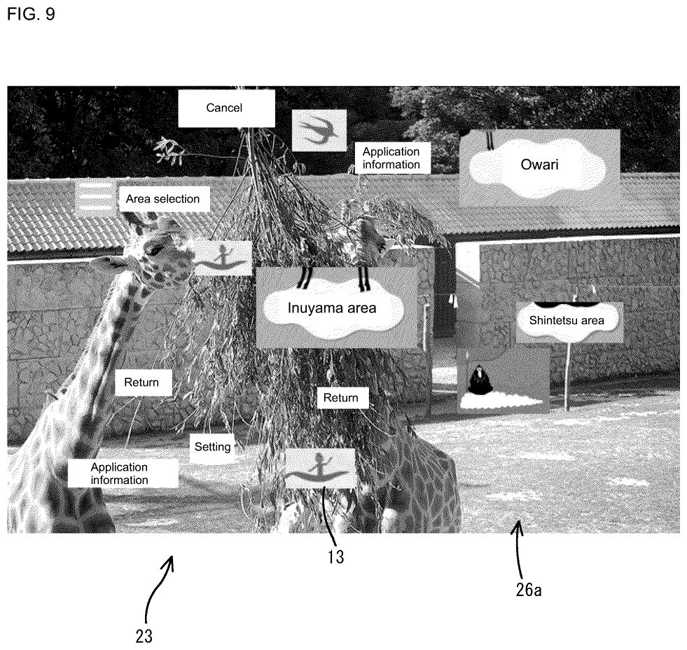

FIG. 9 is a schematic diagram of an image in comparative example 1. A background image 26 of the supervised image 23 as illustrated is, for example, an open data image including a large volume of information. This background image corresponds to Background 2 in FIG. 8. The target image is denoted with 13.

### Background 3: Comparative Example 2, Background 4: Comparative Example 3

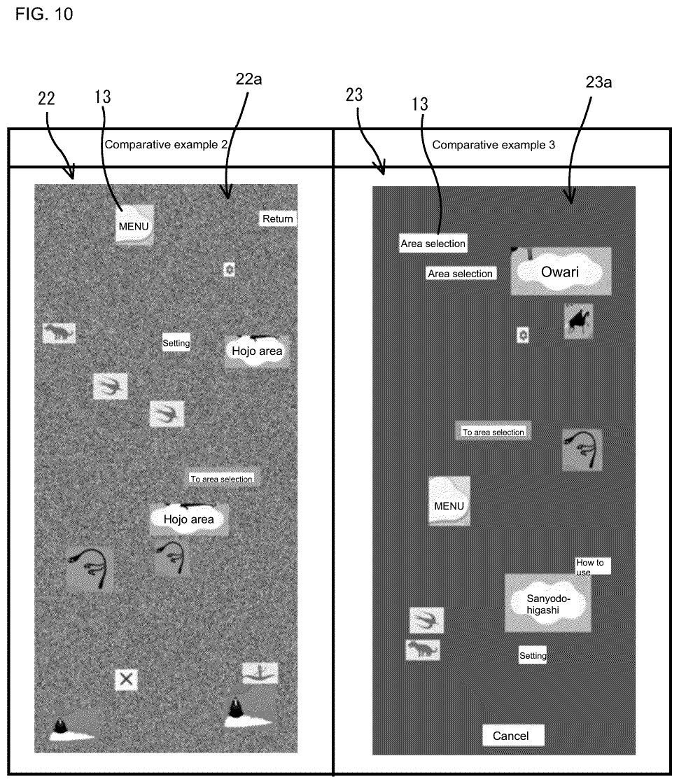

FIG. 10 is a schematic diagram of images in comparative examples 2 and 3. A background image 22a of a supervised image 22 in comparative example 2 as illustrated includes a noise image. This background image corresponds to Background 3 in FIG. 8. A background image 23a of a supervised image 23 in comparative example 3 as illustrated includes an image in a single color of pale green. This background image corresponds to Background 4 in FIG. 8. The target images are denoted with 13. To generate Background 3, for example, a few targets to be arranged in the background are selected first, and the color distribution of the selected targets is calculated statistically. A background in a single color having an average value or a median value of the color distribution is then generated.

Referring back to FIG. 8, for the detection number 1, 200 pieces of training data with the background image of each of Backgrounds 1, 2, 3, and 4 are prepared, and a total of 800 pieces of supervised data are learned.

For detection number 2, 800 pieces of training data with the background image of Background 1 are prepared and learned. For detection numbers 3, 4, and 5, respectively, 800 pieces of training data with the background image of Backgrounds 2, 3, and 4 are prepared and learned, similarly to detection number 2.

For detection number 6, 400 pieces of training data with the background image of each of Backgrounds 1 and 2 are prepared, and a total of 800 pieces of supervised data are learned. For detection numbers 8 and 9, 400 pieces of training data with the background image of each of Backgrounds 1 and 2 are prepared, similarly to detection number 6, and a total of 800 pieces of supervised data are learned for each detection number. For detection numbers 7, a total of 1600 pieces of supervised data are learned.

The numbers of correctly detected targets, as indicated by the data for detection numbers 2 and 3, show good results when Background 1 or Background 2 is the training data. In other words, the background image 15 in the present embodiment provides substantially the same results as when open data is used as the background image.

The data for detection numbers 6 to 9 shows good results when Background 1 and Background 2 are used as the training data. More specifically, when Background 1 and Background 2 are used as the training data, the number of correctly detected targets increases.

Others about Background Image

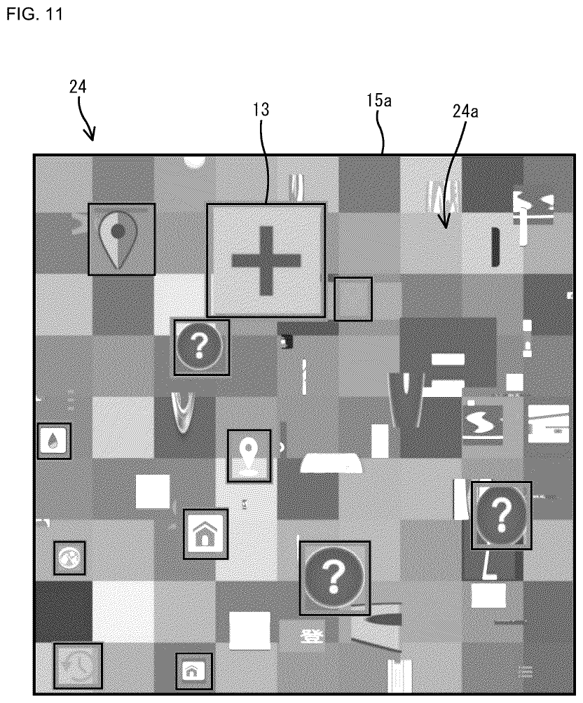

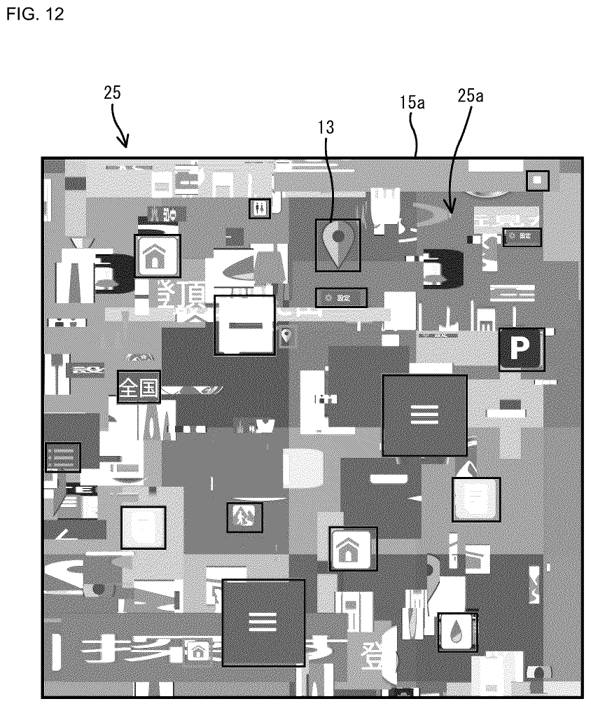

In the supervised data 17, the target images 13 included in the background image 15 are selected randomly, and the transformation process such as enlargement is randomly performed on the target images 13. The number of transformed images 16 to be used for the background image 15 in the background frame 15a can thus vary. FIGS. 11, 12, and 13 show respective examples when the number of transformed images 16 is small, an average, and large.

FIG. 11 is a schematic diagram of the supervised data 17 in another embodiment. In a background image 24a of a supervised image 24 as illustrated, the number of transformed images 16 arranged in the background frame 15a is smaller than the average in the supervised dataset 20.

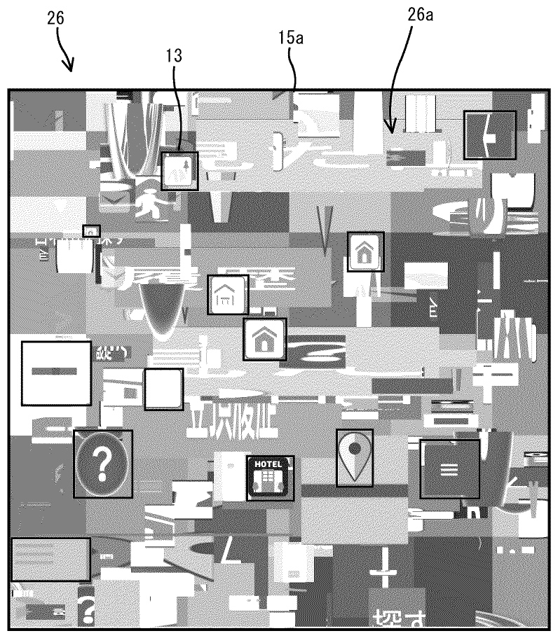

FIG. 12 is a schematic diagram of the supervised image 15 in the supervised data 17 in another embodiment. In a background image 25a of a supervised image 25 as illustrated, the number of transformed images 16 arranged in the background frame 15a is substantially the same as the average in the supervised dataset 20.

FIG. 13 is a schematic diagram of the supervised image 15 in the supervised data 17 in another embodiment. In a background image 26a of a supervised image 26 as illustrated, the number of transformed images 16 arranged in the background frame 15a is larger than the average in the supervised dataset 20.

### 5. Other Embodiments

Another embodiment will now be described. The supervised data 17 in the modification described below is substantially the same as the supervised data 17 described above. Like reference numerals denote like elements, and such elements will not be described.

### Modification

The background image in the modification includes, in addition to the target images 13, images other than the target images.

### 6. Others

The items additionally described in the above embodiments may be combined as appropriate.

### 7. Overview

(1) The supervised data generation programs 36 and 36a (the supervised data generation method 27 and the supervised data generation apparatus 1) generate the supervised data 17 to generate the trained model 10 for outputting the result from identifying a target 12 in response to input image data of the image 11 including the target 12 corresponding to the target image 13. The program causes a computer to perform operations including selecting the first target image 13a from the image group 14 including multiple different target images 13 and performing the transformation process to generate the background image 15, and selecting the second target images 13b from the image group 14 and combining the second target images 13b with the background image 15 to generate the supervised data 17.

The background image 15 resembles the target images 13 and is almost indistinguishable, providing abundant background information to a trained model to increase the training efficiency. The background image 15 can be generated with the target images 13 without preparing open data.
(2) In the supervised data generation programs 36 and 36a described above, the first target image 13a is divided, and the transformation process is performed on the divided image, allowing the supervised data 17 to be artificially increased easily.
(3) The data structure of the supervised data 17 includes the image data of the supervised image 19 for generating the trained model 10 for outputting the result from identifying a target 12 in response to input image data of the image 11 including the target 12 corresponding to the target image 13. The supervised image 19 includes the second target images 13b selected from the image group 14 including the multiple target images 13 corresponding to the targets 12 to be identified from one another by the trained model 10, and the background image 15 located around the second target images 13b. The background image 15 includes the transformed images 16 resulting from the transformation process performed on the first target images 13a selected from the image group 14.

The trained model generated with the supervised data 17 using the background image 15 generated with the target images 13 can have the same capability of detecting the target 12 as the trained model generated with the supervised data using the background image 21a generated with open data.
(4) The data structure of the supervised data described above further includes the positional information 18 about the second target images 13b with respect to the background image 15, allowing the supervised data to be used as the supervised data 17.
(5) The trained model 10 is generated by causing the computer to perform operations including selecting the first target image 13a from the image group 14 including multiple different target images 13 and performing the transformation process to generate the background image 15, and selecting the second target images 13b from the image group 14 and combining the second target images 13b with the background image 15 to generate multiple pieces of supervised data 17. The trained model 10 is generated with the multiple pieces of supervised data 17. The trained model 10 outputs the result from identifying a target 12 in response to input image data of the image 11 including the target 12 corresponding to the target image 13.

The trained model 10 can have the same capability of detecting the targets 12 as the trained model generated with supervised data using the background image 21a generated with open data.

### REFERENCE SIGNS LIST

1 supervised data generation apparatus
2 background image generator
3 supervised data generator
4 training apparatus
5 trained model generator
10 trained model
11 captured image
12 target
13 target image
13a first target image
13b second target image
14 image group
15 background image
15a background frame
16 transformed image
17 supervised data
18 positional information
19 supervised image
20 supervised dataset
21 supervised image
21a background image
22 supervised image
22a background image
23 supervised image
23a background image
24 supervised image
24a background image
25 supervised image
25a background image
26 supervised image
26a background image
27 supervised data generation method
30 CPU
31 memory
32 storage device
33 connection port
34 communication circuit
35 bus line
36, 36a program
37 browser program
38 OS

1. A non-transitory storage medium storing a supervised data generation program for generating supervised data to generate a trained model for outputting a result from identifying a target in response to input image data of an image including the target corresponding to a target image, the program causing a computer to perform operations comprising:
selecting a first target image from an image group including a plurality of different target images and performing a transformation process to generate a background image; and
selecting a second target image from the image group and combining the second target image with the background image to generate supervised data.

2. The supervised data generation program according to claim 1, wherein
the transformation process is performed on a divided image of the first target image.

3. A supervised data generation method for generating supervised data to generate a trained model for outputting a result from identifying a target in response to input image data of an image including the target corresponding to a target image, the method being implementable with a computer, the method comprising:
selecting a first target image from an image group including a plurality of different target images and performing a transformation process to generate a background image; and
selecting a second target image from the image group and combining the second target image with the background image to generate supervised data.

4. A supervised data generation apparatus for generating supervised data to generate a trained model for outputting a result from identifying a target in response to input image data of an image including the target corresponding to a target image, the apparatus comprising:
a background image generator configured to select a first target image from an image group including a plurality of different target images and perform a transformation process to generate a background image; and
a supervised data generator configured to select a second target image from the image group and combine the second target image with the background image to generate supervised data.

5. A training apparatus, comprising:
a background image generator configured to select a first target image from an image group including a plurality of different target images and perform a transformation process to generate a background image;
a supervised data generator configured to select a second target image from the image group and combine the second target image with the background image to generate a plurality of supervised data pieces; and
a trained model generator configured to generate, with the plurality of supervised data pieces, a trained model for outputting a result from identifying a target in response to input image data of an image including the target corresponding to a target image.

6. A data structure of supervised data, comprising:
image data of a supervised image for generating a trained model for outputting a result from identifying a target in response to input image data of an image including the target corresponding to a target image,
wherein the supervised image includes
a second target image selected from an image group including a plurality of the target images corresponding to the target to be identified from one another by the trained model, and
a background image located around the second target image, and
the background image includes a transformed image resulting from a transformation process performed on a first target image selected from the image group.

7. The data structure according to claim 6, further comprising:
positional information about the second target image with respect to the background image.
